(19) United States
(12) Patent Application Publication
(10) Pub. No.: US 2006/0215531 A1
(43) Pub. Date: Sep. 28, 2006

(54) Diffraction element and optical disk device

(76) Inventor: Hiroshi Sakai, Nagano (JP)

Correspondence Address: CANTOR COLBURN, LLP, 55 GRIFFIN ROAD SOUTH, BLOOMFIELD, CT, 06002, US

(21) Appl. No.: 11/387,698

(22) Filed: Mar. 23, 2006

(30) Foreign Application Priority Data
Mar. 24, 2005 (JP) 2005-086981

(51) Int. Cl. G11B 7/135

(52) U.S. Cl. 369/112.03

(57) ABSTRACT

A diffraction element includes a plurality of groove parts and a plurality of protruded parts which are alternately arranged with a plurality of the groove parts. The depth dimension between the upper faces of the protruded parts on both sides of the groove part and the bottom part of the groove part varies according to position. The diffraction element may be preferably disposed at a middle position of a forward path as a three-beam generating element that generates a main beam comprised of a 0-order light beam and two sub-beams comprised of diffracted light beams from a laser beam emitted from a laser light source.

### CROSS REFERENCE TO RELATED APPLICATION

The present invention claims priority under 35 U.S.C. §119 to Japanese Application No. 2005-86981 filed Mar. 24, 2005 which is incorporated herein by reference.

### FIELD OF THE INVENTION

An embodiment of the present invention may relate to a diffraction element in which groove parts and projection parts are alternately arranged and may relate to an optical disk device provided with the diffraction element.

### BACKGROUND OF THE INVENTION

Various structures have been proposed to perform recording or reproduction of information on or from an optical disk. Even when various structures are utilized, an optical disk device commonly includes a laser light source, a photo-detector, and an optical system which structures a forward path for guiding a laser beam emitted from a laser light source to an optical disk and a return path for guiding a return light beam reflected by the optical disk to the photo-detector. Further, various diffraction elements are used in the optical disk device.

For example, the following technique has been disclosed. In other words, in order to obtain a tracking error signal by DPP (Differential Push-Pull) method or the like, a main beam comprised of a 0-order (zero-order) light beam and sub-beams comprised of a diffraction light beam are generated from a light beam emitted from a laser light source by a diffraction element, and as the above-mentioned diffraction element, a diffraction element is used in which groove parts are formed in an area smaller than the cross sectional area of a light beam to cancel the offset of tracking with the use of a diffracted light beam and a light beam which is not diffracted (see, for example, Japanese Patent Laid-Open No. Hei 10-162383).

Further, another diffraction element has been proposed in which, in order to sufficiently narrow down the size of a light beam spot on an optical disk, the groove width is set to close to half the width of a grating period near the center area and the groove width near the outer edge portion is set to be different from half the width of the grating period (see, for example, Japanese Patent Laid-Open No. 2004-295954).

However, in the case of the diffraction element which is described in the former prior art, a large difference in the phase of the main beam occurs between an area provided with the groove parts, and a flat portion which is not provided with the groove parts, and thus the occurrence of aberration is not prevented.

Further, in the case of the diffraction element which is described in the latter prior art, since the duty ratio of a grating is changed, the high-order diffraction efficiency such as 3rd-order, 5th-order, 7th-order diffracted light beams and the like becomes higher in the area where the duty ratio is shifted from 50:50. As a result, in the case that the utilization efficiency of a laser beam is to be enhanced even a little as the case of an optical disk device for recording, a negative effect may be provided.

### BRIEF DESCRIPTION OF THE INVENTION

In view of the problems described above, an embodiment of the present invention may advantageously provide a diffraction element which is capable of improving the degree of freedom of the “NA” numerical aperture and the optical magnification by being capable of setting the spot shape and the diffraction efficiency in desired conditions, and may advantageously provide an optical disk device which utilizes the diffraction element.

Thus, according to an embodiment of the present invention, there may be provided a diffraction element including a plurality of groove parts and a plurality of protruded parts which are alternately arranged with a plurality of the groove parts, and the depth dimension which is formed between the upper faces of the protruded parts on both sides of the groove part and the bottom part of the groove part varies according to position.

The diffraction element in accordance with an embodiment may be used in an optical disk device for performing recording and/or reproduction of information on or from an optical disk. The optical disk device includes a laser light source, a photo-detector, and an optical system for structuring a forward path that guides a laser beam emitted from the laser light source to an optical disk and a return path that guides a return light beam reflected by the optical disk to the photo-detector. The optical system includes the diffraction element, which is disposed at a middle position of the forward path as a three-beam generating element for generating a main beam comprised of a 0-order light beam and two sub-beams comprised of diffracted light beams from the laser beam emitted from the laser light source.

In accordance with an embodiment, since the depth dimension of the groove part of the diffraction element varies according to position, the spot shape and the diffraction efficiency can be set in desired conditions and the degree of freedom of the degree of aperture and the optical magnification can be improved. For example, in the case that the diffraction element to which the present invention is applied is used as a three-beam generating element in an optical disk device, when a main beam comprised of a 0-order light beam and sub-beams comprised of diffracted light beams are formed from a laser beam emitted from a laser light source, the groove part of the diffraction element is formed such that the depth dimension between the upper faces of the protruded parts on both sides of the groove part and the bottom part of the groove part varies according to position. Therefore, when the light beam is passed through the diffraction element, since a part of the light beam is diffracted in comparison with the light beam before passing through the diffraction element, and thus the peak shape of the zero-order light beam becomes, for example, to be the shape that the level of the lower slope portion is raised by the quantity of decreasing in the center region. Accordingly, with respect to the zero-order light beam which is incident on an objective lens, a similar effect as when “NA” numerical aperture is increased can be obtained, and thus the spot diameter of a main beam can be made smaller when the main beam is converged on the track of an optical disk. As described above, the spot shape and the diffraction efficiency can be set in desired conditions and thus the degree of freedom of the degree of aperture and the optical magnification can be improved. Further, the duty ratio of a grating in the diffraction element may be set to be 50:50 and thus the generation of high-order diffraction light beams can be restrained. Therefore, the spot diameters of the sub-beams which are converged on an optical disk are enlarged. Accordingly, since the tolerance of positional accuracy between a track and the sub-beams becomes wider, working efficiency can be improved when an optical disk device is manufactured. Further, even in optical disks with different track pitches, a tracking error signal can be obtained properly.

In accordance with an embodiment, the depth dimension of the groove part may vary in the longitudinal direction of the groove part in a step manner or may continuously vary in the longitudinal direction of the groove part.

In accordance with an embodiment, the depth dimensions of a plurality of the groove parts may be different.

In accordance with an embodiment, the center position in the depth direction of the groove part may be set to be the same height position in the longitudinal direction of the groove part. According to the structure described above, the generation of astigmatism due to the diffraction element can be prevented.

In accordance with an embodiment, the center position in the depth direction of the groove part may vary in the longitudinal direction of the groove part.

In accordance with an embodiment, the center positions in the depth direction of a plurality of the groove parts may be set to be the same height position. According to the structure described above, the generation of astigmatism due to the diffraction element can be prevented.

In accordance with an embodiment, the center positions in the depth direction of a plurality of the groove parts may be different.

In accordance with an embodiment, the groove parts and the protruded parts which are alternately arranged each other may be formed so as to form a center region where a depth dimension between the bottom part of the groove part and the upper face of the protruded part is large and both side regions where a depth dimension is smaller than the depth dimension of the center region, and an incident area of a laser beam from a laser light source is set to extend over the center region and the both side regions. In this case, it may be preferable that the width dimension of each of a plurality of the groove parts and the width dimension of each of a plurality of the protruded parts are equal to each other and the duty ratio of a grating is 50:50.

In accordance with an embodiment, the bottom part of the groove part in the center region may be formed deeper than the bottom part of the groove part in the both side regions, and the upper face of the protruded part in the center region may be formed higher than the upper face of the protruded part in the both side regions, and thereby the depth dimension in the center region is set to be large and the depth dimension in the both side regions is set to be small with respect to the center region.

In accordance with an embodiment, the bottom part of the groove part in the center region may be formed in a curved shape which is concaved at a center portion and which is continuously formed with the bottom part of the groove part in the both side regions, and thereby the depth dimension in the center region is set to be large and the depth dimension in the both side regions is set to be small with respect to the center region.

In accordance with an embodiment, the bottom part of the groove part in the center region is formed deeper than the bottom part of the groove part in the both side regions in a direction perpendicular to the longitudinal direction of the groove part, and thereby the depth dimension in the both side regions is set to be smaller than the depth dimension in the center region.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an explanatory view showing a schematic structure of an optical disk device in accordance with a first embodiment of the present invention.

FIG. 2(a) is a plan view showing a diffraction element which is used in the first embodiment, FIG. 2(b) is a sectional view showing the diffraction element which is cut along the longitudinal direction of a groove part, and FIG. 2(c) is its perspective view.

FIGS. 3(a), 3(b), 3(c), 3(d) and 3(e) are explanatory views showing variations of the light intensity distribution of a 0-order light beam before and after the transmission of the diffraction element which is used in the first embodiment.

FIG. 4(a) is an explanatory view showing a state where spots are formed on an optical disk in an optical disk device to which the present invention is applied. FIG. 4(b) is an explanatory view showing a state that spots are formed on an optical disk in a conventional optical disk device.

FIG. 5(a) is a plan view showing a diffraction element which is used in a second embodiment of the present invention, FIG. 5(b) is a sectional view showing the diffraction element which is cut along the longitudinal direction of a groove part, and FIG. 5(c) is its perspective view.

FIG. 6(a) is a plan view showing a diffraction element which is used in a third embodiment of the present invention, FIG. 6(b) is a sectional view showing the diffraction element which is cut along the longitudinal direction of a groove part, and FIG. 6(c) is its perspective view.

FIG. 7(a) is a plan view showing a diffraction element which is used in a fourth embodiment of the present invention, FIG. 7(b) is a sectional view showing the diffraction element which is cut along the longitudinal direction of a groove part, FIG. 7(c) is a sectional view showing the diffraction element which is cut in a direction perpendicular to the longitudinal direction of the groove part and FIG. 7(d) is its perspective view.

### DETAILED DESCRIPTION OF THE PREFERRED EMBODIMENTS

### First Embodiment

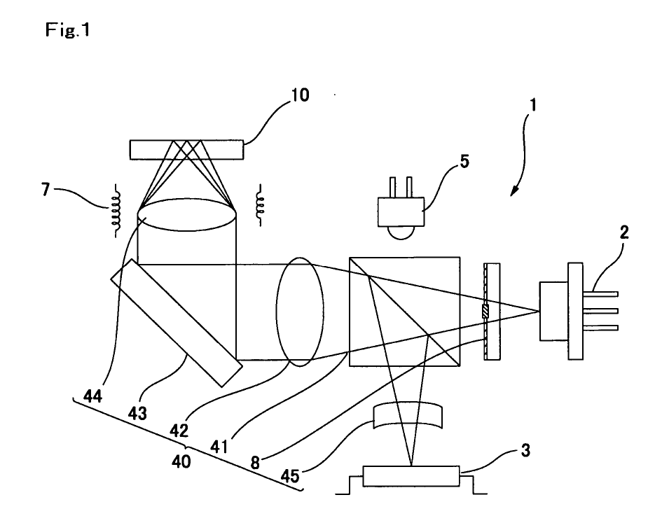

FIG. 1 is an explanatory view showing a schematic structure of an optical disk device in accordance with a first embodiment of the present invention.

In FIG. 1, an optical disk device 1 in accordance with the first embodiment includes a semiconductor laser 2 for emitting a laser light beam with, for example, the wavelength of 650 nm and a photo-detector 3. Further, the optical disk device 1 includes a beam splitter 41, a collimating lens 42, a rising mirror 43 and an optical system 40 provided with an objective lens 44 from the semiconductor laser 2 to an optical recording disk 10. A forward path through which the laser beam emitted from the semiconductor laser 2 is guided to the optical recording disk 10 is structured by these optical elements. Further, the optical system 40 is provided with a sensor lens 45 between the beam splitter 41 and the photo-detector 3. A return path through which the return light beam reflected by the optical disk 10 is guided to the photo-detector 3 is structured by the objective lens 44, the rising mirror 43, the collimating lens 42, the beam splitter 41 and the sensor lens 45. A front monitor 5 (photo-detector for monitor) for detecting a light beam reflected by the beam splitter 41 among the light beam which is directed to the optical disk 10 from the semiconductor laser 2 is disposed on the rear side of the beam splitter 41 with respect to the photo-detector 3.

The photo-detector 3 is used to generate a focusing error signal and a tracking error signal when information is recorded or reproduced by detecting the return light beam reflected by the optical disk 10. The focusing error signal and the tracking error signal are fed back to an objective lens drive device 7.

The optical disk 10 is, for example, a DVD-RAM (Digital Versatile Disk Random Access Memory). In a DVD-RAM, a land and a groove with wobble (undulation) are alternately formed in a concentric manner (not shown) and both the land and the groove are used as a track on which a pit is formed. A signal obtained from wobble is used for pull-in of a clock.

In the optical disk device 1 in accordance with this embodiment, a diffraction element 8 comprised of a grating or a hologram element is disposed between the semiconductor laser 2 and the beam splitter 41 for generating a sub-beam comprised of −1st-order diffracted light beam, a main beam comprised of 0-order light beam, and a sub-beam comprised of +1st-order diffracted light beam from the laser beam emitted from the semiconductor laser 2. Therefore, reproduction of information can be performed by the main beam comprised of a 0-order light beam which is converged on a track of the optical disk 10 through the objective lens 44 and the return light beam which is detected by the photo-detector 3. Further, recording of information can be performed by the main beam comprised of a 0-order light beam which is converged on a track of the optical disk 10 through the objective lens 44. In addition, a tracking error signal can be obtained by means of that a sub-beam comprised of −1st-order diffracted light beam and a sub-beam comprised of +1st-order diffracted light beam are converged through the objective lens 44 at positions interposing the spot of the main beam in the tangential direction of a track of the optical recording disk 10 and by detecting the return light beam with the photo-detector 3 and by utilizing a DPP method or the like.

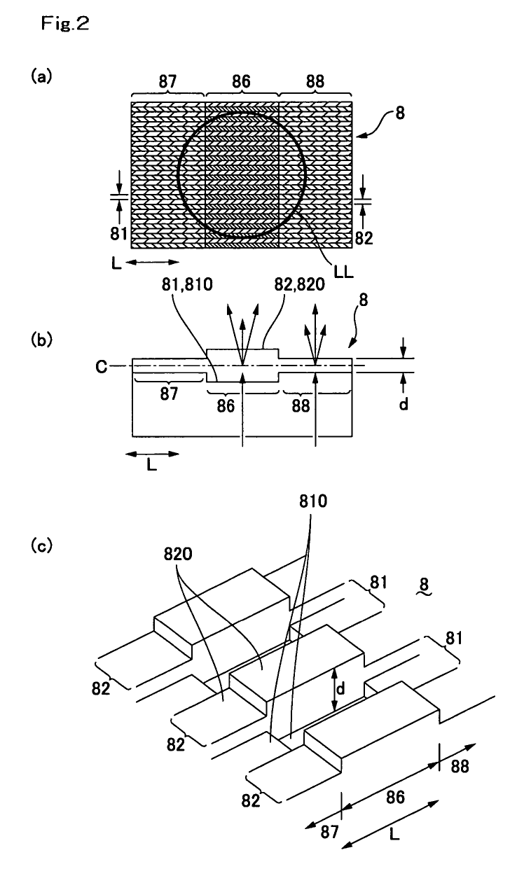

FIG. 2(a) is a plan view showing a diffraction element which is used in the first embodiment, FIG. 2(b) is a sectional view showing the diffraction element which is cut along the longitudinal direction of a groove part, and FIG. 2(c)is its perspective view.

As shown in FIGS. 2(a), 2(b) and 2(c), in the optical disk device 1 in accordance with the first embodiment, all the groove parts 81 of the diffraction element 8 are formed such that the depth dimension “d” between the upper faces 820 of protruded parts 82 interposing the groove part 81 from both sides and the bottom part 810 of the groove part 81 is varied according to position. In this embodiment, the depth dimension “d” of every groove part 81 varies in a stepwise manner in the longitudinal direction (as shown by the arrow “L”) of the groove part 81. In other words, in all groove parts 81, the bottom part 810 of the center region 86 in the longitudinal direction is formed lower by one step length than both side regions 87, 88 and the upper face 820 of the protruded part 82 is formed higher by one step length than both the side regions 87, 88. The depth dimension “d” in the center region 86 is large. Therefore, ±1st-order diffraction efficiency is high in the center region 86. On the other hand, in both the side regions 87, 88 in the longitudinal direction of the groove part 81, the bottom part 810 of the groove part 81 is higher by one step length than that of the center region 86 and the upper face 820 of the protruded part 82 is lower by one step length than that of the center region 86. The depth dimension “d” of both the side regions 87, 88 is small. Therefore, ±1st-order diffraction efficiency is low in both the side regions 87, 88, In accordance with the first embodiment, the center position (shown by the alternate long and short dash line “C” in FIG. 2(b)) of the groove part 81 in its depth direction is set to be the same height position along the longitudinal direction of the groove part 81. In addition, the center positions in the depth direction of adjacent groove parts 81 are respectively set to be the same height position. In this embodiment, in all the regions in the diffraction element 8, the width dimension of the groove part 81 and the width dimension of the protruded part 82 are equal to each other and thus all the duty ratio of the grating is 50:50.

In the diffraction element 8 structured as described above, the center region 86 where the groove part 81 is deep is formed in a stripe shape in a direction perpendicular to the longitudinal direction. The laser beam emitted from the semiconductor laser 2 is incident on the diffraction element 8 so as to extend over the center region 86 where the groove parts 81 are formed deep and both the side regions 87, 88 where the groove parts 81 are formed shallow. The far field pattern of the laser beam emitted from the semiconductor laser 2 is elliptical. Its major axis direction corresponds to a direction perpendicular to the longitudinal direction of the groove part 81 and its minor axis direction corresponds to the longitudinal direction of the groove part 81. Further, the region of the laser beam emitted from the semiconductor laser 2 which is shown by the circle “LL” in FIG. 2(a) is utilized for being converged on the optical recording disk 10.

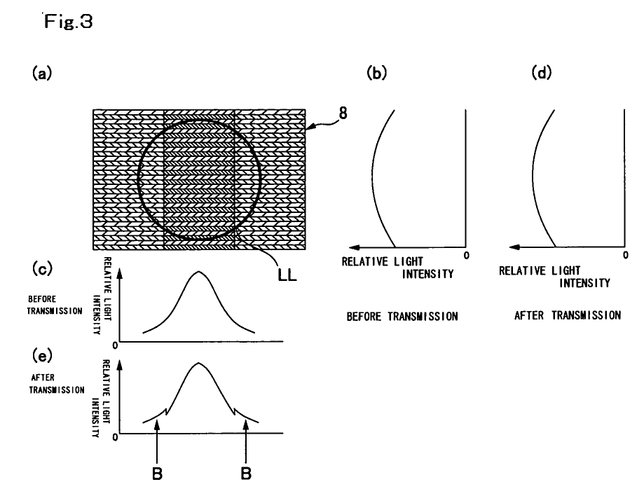

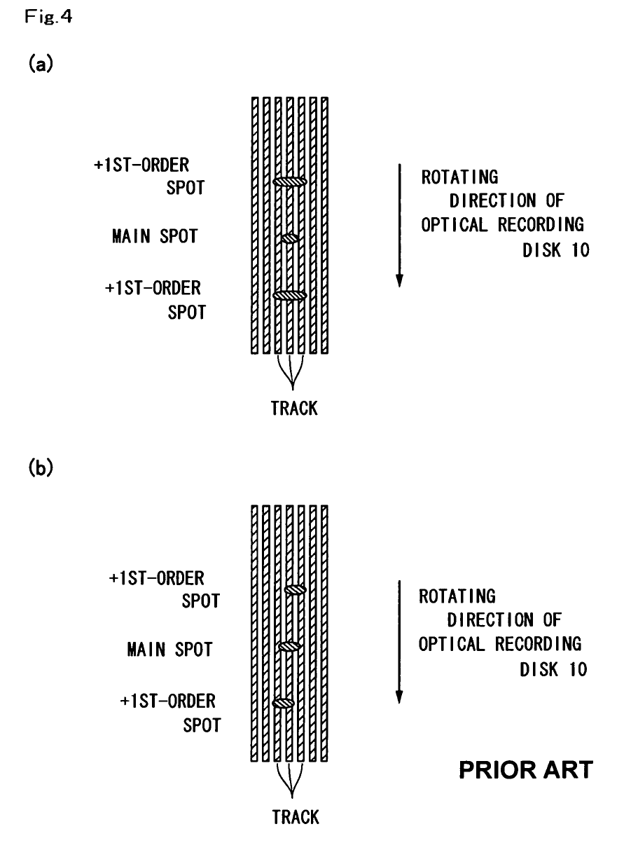

FIGS. 3(a), 3(b), 3(c), 3(d) and 3(e) are explanatory views showing variations of the light intensity distribution of a 0-order light beam before and after the transmission of the diffraction element which is used in the first embodiment. FIG. 3(a) is a plan view of the diffraction element 8. The light intensity distributions of the incident light to the diffraction element 8 are shown in FIGS. 3(b) and 3(c) which correspond to the direction to the diffraction element 8 shown in FIG. 3(a). The light intensity distributions of the emitted light beam from the diffraction element 8 are shown in FIGS. 3(d) and 3(e) which correspond to the direction to the diffraction element 8 shown in FIG. 3(a). FIG. 4(a) is an explanatory view showing a state where spots are formed on an optical disk in an optical disk device to which the present invention is applied. FIG. 4(b) is an explanatory view showing a state that spots are formed on an optical disk in a conventional optical disk device.

As shown in FIGS. 3(a), 3(b) and 3(d), in the optical disk device 1 in accordance with the first embodiment, the light quantity distribution of the laser light beam when the diffraction element 8 is cut in a direction perpendicular to the groove part 81 of the diffraction element 8 does not indicate a large variation between before and after the transmission through the diffraction element 8. However, as shown in FIGS. 3(a), 3(c) and 3(e), the light quantity distribution of the laser light beam when the diffraction element 8 is cut in a direction parallel to the groove part 81 of the diffraction element 8 indicates a large variation between before and after the transmission through the diffraction element 8. In other words, in this diffraction element 8, the ±1st-order diffraction efficiencies in the center region 86 in the longitudinal direction of the groove part 81 are high but the ±1st-order diffraction efficiencies in both the side regions 87, 88 are low. Therefore, the optical intensity of the zero-order light beam emitted through the center region 86 decreases largely but the optical intensity of the zero-order light beam emitted through both the side regions 87, 88 decreases slightly. Accordingly, the peak shape of the zero-order light beam becomes to be the shape in which, although the light quantity decreases largely in the center region, the level of the lower slope portion is raised as shown by the arrow “B” in FIG. 3(e). As a result, with respect to the zero-order light beam which is incident on the objective lens 44, similar effect as the “NA” numerical aperture is increased can be obtained.

As a result, FIG. 4(a) shows an example in accordance with the first embodiment of the present invention when the main beam is converged on the optical disk 10 and FIG. 4 (b) shows a conventional example. According to this embodiment, the spot diameter of the main spot which is converged on the optical disk 10 can be made smaller. Therefore, even when the power of the laser beam emitted from the semiconductor laser 2 is small, recording on the optical recording disk 10 can be performed, power saving and cost reduction can be attained, and measures for heat generation can be easily performed.

Further, in the first embodiment, all the duty ratio of a grating in the diffraction element 8 may be set to be 50:50 and thus the generation of high-order diffraction light beams can be restrained. Therefore, in accordance with this embodiment, when sub-beams are converged on the optical disk 10, both the spot diameters of +1st-order sub-spot and −1st-order sub-spot are enlarged in comparison with the conventional example. Accordingly, since the tolerance of positional accuracy between a track and the sub-beams becomes wider, when the optical disk device 1 is manufactured, working efficiency can be improved. Moreover, even when optical disks 10 are provided with different track pitches, a tracking error signal can be appropriately obtained.

In addition, in the first embodiment, the center position in the depth direction of the groove part 81 (shown by the alternate long and short dash line “C” in FIG. 2(b)) is set to be the same height position in the longitudinal direction of the groove part 81 and, furthermore, the center positions in the depth direction of adjacent groove parts 81 are set to be the same height position. Therefore, astigmatism does not occur.

### Second Embodiment

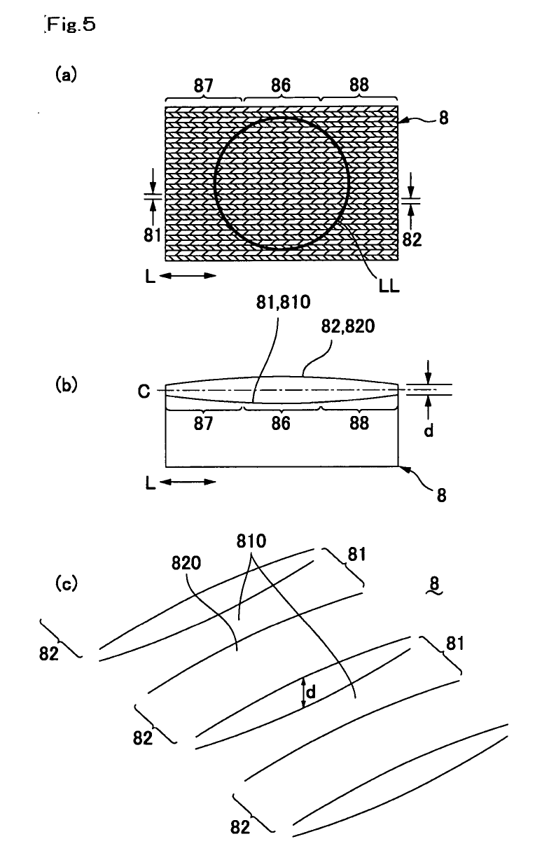

FIG. 5(a) is a plan view showing a diffraction element which is used in a second embodiment of the present invention, FIG. 5(b) is a sectional view showing the diffraction element which is cut along the longitudinal direction of a groove part, and FIG. 5(c) is its perspective view. The basic structures in the second, a third and a fourth embodiments described below are common to the first embodiment and thus the same notational symbols are used in the common portions.

As shown in FIGS. 5(a), 5(b) and 5(c), also in the optical disk device 1 in accordance with a second embodiment, similarly to the first embodiment, the depth dimension “d” between the upper faces 820 of the protruded parts 82 on both sides of the groove part 81 and the bottom part 810 of the groove part 81 varies according to the position in all the groove parts 81 of the diffraction element 8.

In the second embodiment, similarly to the first embodiment, the depth dimension “d” in all groove parts 81 varies continuously in the longitudinal direction (shown by the arrow “L”) of the groove part 81. In other words, in all groove parts 81, the bottom part 810 is formed in a curved shape such that its center portion in the longitudinal direction is concaved and the upper faces 820 of all the protruded parts 82 are formed in a curved shape such that its center portion in the longitudinal direction is formed to be convex. Therefore, in the center region 86 in the longitudinal direction of all the groove parts 81, the bottom part 810 of the groove part 81 is formed to be lower in comparison with those of the both side regions 87, 88 and the upper face 820 of the protruded part 82 is formed to be higher in comparison with those of the both side regions 87, 88, and thus the depth dimension “d” in the center region 86 is larger. Accordingly, ±1st-order diffraction efficiencies are high in the center region 86. On the other hand, in both the side regions 87, 88 in the longitudinal direction of the groove part 81, the bottom part 810 of the groove part 81 is formed to be higher in comparison with that of the center region 86 and the upper face 820 of the protruded part 82 is formed to be lower in comparison with that of the center region 86 and thus the depth dimension “d” in both the side regions 87, 88 is smaller. Therefore, ±1st-order diffraction efficiencies are low in both the side regions 87, 88. In accordance with the second embodiment, the center position (shown by the alternate long and short dash line “C” in FIG. 5(b)) in the depth direction of the groove part 81 is set to be the same height position along the longitudinal direction of the groove part 81. In addition, the center positions in the depth direction of adjacent groove parts 81 are respectively set to be the same height position. In this embodiment, in either region in the diffraction element 8, the width dimension of the groove part 81 and the width dimension of the protruded part 82 are equal to each other and thus all the duty ratio of the grating is 50:50.

In the diffraction element 8 formed as described above, a clear boundary line is not formed between the center region 86 where the depth of the groove part 81 is deep and both the side regions 87, 88 where the depth of the groove part 81 is shallow. However, the center region 86 is successively formed in a stripe shape in a direction perpendicular to the longitudinal direction. The laser beam emitted from the semiconductor laser 2 is incident on the diffraction element 8 so as to extend over the center region 86 where the depth of the groove part 81 is deep and both the side regions 87, 88 where the depth of the groove part 81 is shallow. The far field pattern of the laser beam emitted from the semiconductor laser 2 is elliptical. Its major axis direction corresponds to a direction perpendicular to the longitudinal direction of the groove part 81 and its minor axis direction corresponds to the longitudinal direction of the groove part 81. Further, the region of the laser beam emitted from the semiconductor laser 2 which is shown by the circle “LL” in FIG. 5(a) is utilized for being converged on the optical recording disk 10.

Also in the optical disk device 1 as structured above, as described in the first embodiment with reference to FIGS. 3(a), 3(b), 3(c), 3(d) and 3(e), the ±1st-order diffraction efficiencies in the center region 86 in the longitudinal direction of the groove part 81 in the diffraction element 8 are high but the ±1st-order diffraction efficiencies in both the side regions 87, 88 are low. Therefore, the optical intensity of the zero-order light beam emitted through the center region 86 decreases largely but the optical intensity of the zero-order light beam emitted through both the side regions 87, 88 decreases only little. Accordingly, the peak shape of the zero-order light beam becomes to be the shape in which, although the light quantity decreases largely in the center region, the level of the lower slope portion is raised and thus, with respect to the zero-order light beam which is incident on the objective lens 44, similar effect as the “NA” numerical aperture is increased can be obtained. As a result, as described with reference to FIG. 4(a) in the first embodiment, when the main beam is converged on the optical recording disk 10, the spot diameter of the main spot which is converged on the optical disk 10 can be made smaller. Therefore, even when the power of the laser beam emitted from the semiconductor laser 2 is small, recording to the optical recording disk 10 can be performed, power saving and cost reduction can be attained, and measures for heat generation can be easily performed.

Further, in the second embodiment, all the duty ratio of a grating in the diffraction element 8 may be set to be 50:50 and thus the generation of high-order diffraction light beams can be restrained. Therefore, when sub-beams are converged on the optical disk 10, both the spot diameters of +1st-order sub-spot and −1st-order sub-spot are enlarged in comparison with the conventional example. Accordingly, since the tolerance of positional accuracy between a track and the sub-beams becomes wider, when the optical disk device 1 is manufactured, working efficiency can be improved. Moreover, even when optical recording disks 10 are provided with different track pitches, a tracking error signal can be appropriately obtained.

In addition, in the second embodiment, the center position in the depth direction of the groove part 81 (shown by the alternate long and short dash line “C” in FIG. 5(b)) is set to be the same height position in the longitudinal direction of the groove part 81 and, furthermore, the center positions in the depth direction of adjacent groove parts 81 are set to be the same height position. Therefore, astigmatism does not occur.

### Third Embodiment

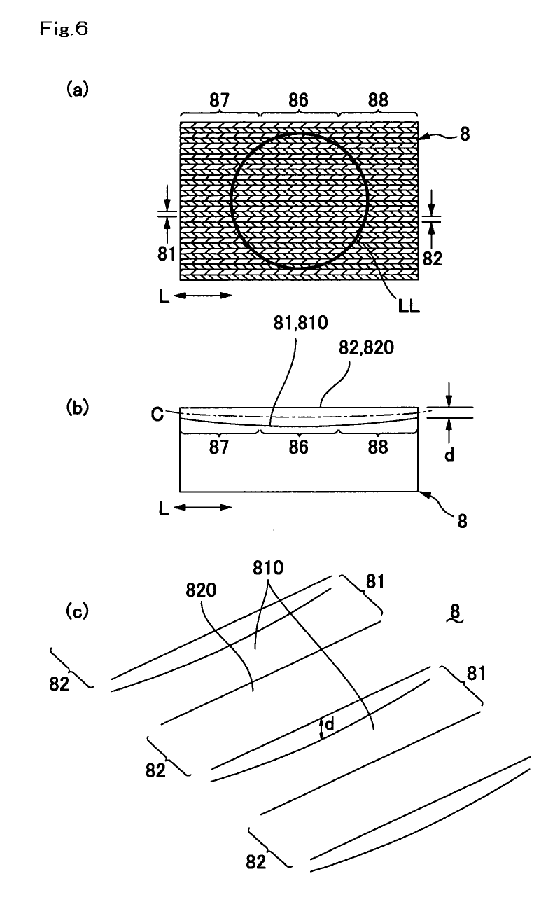

FIG. 6(a) is a plan view showing a diffraction element which is used in a third embodiment of the present invention, FIG. 6(b) is a sectional view showing the diffraction element which is cut along the longitudinal direction of a groove part, and FIG. 6(c) is its perspective view.

As shown in FIGS. 6(a), 6(b) and 6(c), also in the optical disk device 1 in accordance with a third embodiment, similarly to the first embodiment, the depth dimension “d” between the upper faces 820 of the protruded parts 82 on both sides of the groove part 81 and the bottom part 810 of the groove part 81 varies according to the position in all the groove parts 81 of the diffraction element 8. In other words, in all groove parts 81, the bottom part 810 is formed in a curved shape such that its center portion in the longitudinal direction is concaved and the upper faces 820 of all the protruded parts 82 are formed in a flat face. Therefore, in the center region 86 in the longitudinal direction of all the groove parts 81, the bottom part 810 of the groove part 81 is formed to be lower in comparison with those of the both side regions 87, 88 and thus the depth dimension “d” in the center region 86 is larger. Accordingly, 1st-order diffraction efficiencies are high in the center region 86. On the other hand, in both the side regions 87, 88 in the longitudinal direction of the groove part 81, the bottom part 810 of the groove part 81 is formed to be higher in comparison with that of the center region 86 and thus the depth dimension “d” in both the side regions 87, 88 is smaller. Therefore, ±1st-order diffraction efficiencies are low in both the side regions 87, 88. Further, similarly to the first and second embodiments, in either region in the diffraction element 8, the width dimension of the groove part 81 and the width dimension of the protruded part 82 are equal to each other and thus all the duty ratio of the grating is 50:50.

However, in the third embodiment, the center position (shown by the alternate long and short dash line “C” in FIG. 6(b)) in the depth direction of the groove part 81 varies in the longitudinal direction of the groove part 81, which is different from the first and second embodiments. In the third embodiment, the center position in the depth direction of the groove part 81 is formed to be concaved at the center region 86.

In the diffraction element 8 structured as described above, a clear boundary line is not formed between the center region 86 where the depth of the groove part 81 is deep and both the side regions 87, 88 where the depth of the groove part 81 is shallow. However, the center region 86 is successively formed in a stripe shape in a direction perpendicular to the longitudinal direction. The laser beam emitted from the semiconductor laser 2 is incident on the diffraction element 8 so as to extend over the center region 86 where the depth of the groove part 81 is deep and both the side regions 87, 88 where the depth of the groove part 81 is shallow. The far field pattern of the laser beam emitted from the semiconductor laser 2 is elliptical. Its major axis direction corresponds to a direction perpendicular to the longitudinal direction of the groove part 81 and its minor axis direction corresponds to the longitudinal direction of the groove part 81. Further, the region of the laser beam emitted from the semiconductor laser 2 which is shown by the circle “LL” in FIG. 6(a) is utilized for being converged on the optical recording disk 10.

Also in the optical disk device 1 as structured above, the peak shape of the zero-order light beam becomes to be the shape in which, although the light quantity decreases largely in the center region, the level of the lower slope portion is raised and thus the spot diameter of the main spot which is converged on the optical recording disk 10 can be made smaller. Therefore, even when the power of the laser beam emitted from the semiconductor laser 2 is small, recording to the optical recording disk 10 can be performed. Further, all the duty ratio of a grating in the diffraction element 8 is set to be 50:50 and thus the generation of high-order diffraction light beams can be restrained. Therefore, both the spot diameters of +1st-order sub-spot and −1st-order sub-spot are enlarged. Accordingly, since the tolerance of positional accuracy between a track and the sub-beams becomes wider, when the optical disk device 1 is manufactured, working efficiency can be improved.

Further, in the third embodiment, the center positions (shown by the alternate long and short dash line “C” in FIG. 5(b)) in the depth direction of the adjacent groove parts 81 are set to be the same height position but the center position varies in the longitudinal direction of the groove part 81. This pattern may correspond to the astigmatism caused by other optical elements which are used in the optical disk device 1. Therefore, according to the third embodiment, the astigmatism caused by the optical system used in the optical disk device 1 can be absorbed by using the diffraction element 8.

### Fourth Embodiment

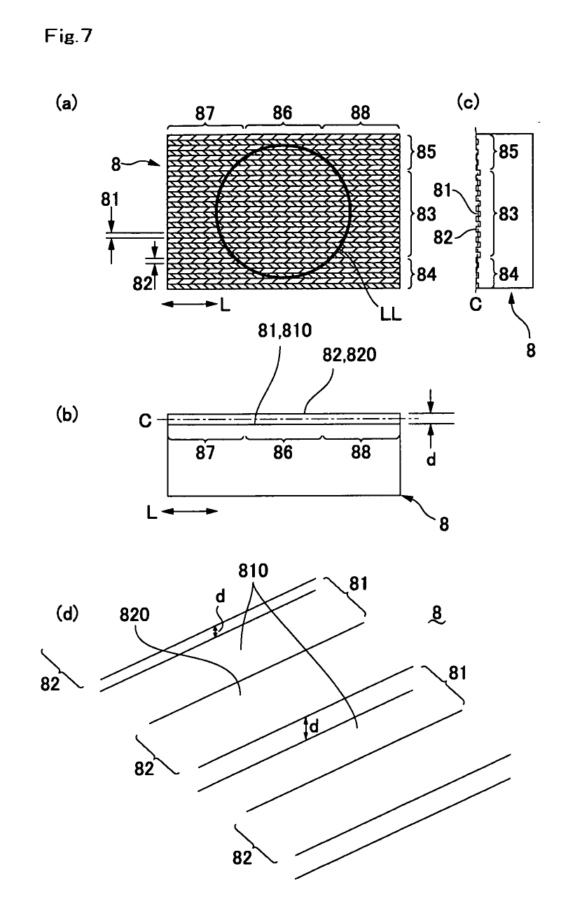

FIG. 7(a) is a plan view showing a diffraction element which is used in a fourth embodiment of the present invention, FIG. 7(b) is a sectional view showing the diffraction element which is cut along the longitudinal direction of a groove part, FIG. 7(c) is a sectional view showing the diffraction element which is cut in a direction perpendicular to the longitudinal direction of the groove part and FIG. 7(d) is its perspective view.

As shown in FIGS. 7(a), 7(b) and 7(d), in the optical disk device 1 in accordance with the fourth embodiment, both the bottom part 810 of the groove part 81 and the upper face 820 of the protruded part 82 of the diffraction element 8 are formed in a flat face. Further, in the longitudinal direction of the groove part 81 (as shown by the arrow “L”), the depth dimension “d” between the upper faces 820 of the protruded parts 82 on the both sides of the groove part 81 and the bottom part 810 of the groove part 81 is set to be constant regardless of the position.

In accordance with the fourth embodiment, the upper face parts 820 of adjacent protruded parts 82 are set to be the same height position in the direction perpendicular to the longitudinal direction of the groove part 81. However, as shown in FIGS. 7(a), 7(c) and 7(d), in the bottom parts 810 of the groove parts 81, the center region 83 in the direction perpendicular to the longitudinal direction of the groove part 81 is formed to be lower in comparison with both the side regions 84, 85. Therefore, in the groove parts 81 of the diffraction element 8, the depth dimension “d” between the upper faces 820 of the protruded parts 82 on both sides of the groove part 81 and the bottom part 810 of the groove part 81 varies according to the position. Accordingly, ±1st-order diffraction efficiencies are high in the center region 83 where the depth of the groove part 81 is deep and ±1st-order diffraction efficiencies are low in both the side regions 84, 85 where the depth is shallow. Further, similarly to the first, the second and the third embodiments, also in the fourth embodiment, in either region in the diffraction element 8, the width dimension of the groove part 81 and the width dimension of the protruded part 82 are equal to each other and thus all the duty ratio of the grating is 50:50.

Further, in the fourth embodiment, the center position (shown by the alternate long and short dash line “C” in FIG. 7(b)) in the depth direction of the groove part 81 is not varied in the longitudinal direction of the groove part 81, which is different from the third embodiment. However, in the fourth embodiment, the center region 83 is formed to be concaved in a direction perpendicular to the longitudinal direction of the groove part 81 with respect to both the side regions 84, 85.

In the diffraction element 8 formed as described above, a clear boundary line is not formed between the center region 83 where the depth of the groove part 81 is deep and both the side regions 84, 85 where the depth of the groove part 81 is shallow. However, the center region 83 is successively formed in a stripe shape in the longitudinal direction of the groove part 81. The laser beam emitted from the semiconductor laser 2 is incident on the diffraction element 8 so as to extend over the center region 83 where the depth of the groove part 81 is deep and both the side regions 84, 85 where the depth of the groove part 81 is shallow. The far field pattern of the laser beam emitted from the semiconductor laser 2 is elliptical. Its major axis direction corresponds to a direction perpendicular to the longitudinal direction of the groove part 81 and its minor axis direction corresponds to the longitudinal direction of the groove part 81. Further, the region of the laser beam emitted from the semiconductor laser 2 which is shown by the circle “LL” in FIG. 7(a) is utilized for being converged on the optical recording disk 10.

Also in the optical disk device 1 as structured above, the optical intensity of the zero-order light beam emitted through the center region 86 decreases largely but the optical intensity of the zero-order light beam emitted through both the side regions 87, 88 decreases little. Therefore, the peak shape of the zero-order light beam becomes to be the shape in which, although the light quantity decreases largely in the center region, the level of the lower slope portion is raised. Accordingly, since the spot diameter of the main spot which is converged on the optical recording disk 10 can be made smaller, even when the power of the laser beam emitted from the semiconductor laser 2 is small, recording to the optical recording disk 10 can be performed. Further, all the duty ratio of a grating in the diffraction element 8 is set to be 50:50 and thus the generation of high-order diffraction light beams can be restrained. Therefore, both the spot diameters of +1st-order sub-spot and −1st-order sub-spot are enlarged. Accordingly, since the tolerance of positional accuracy between a track and the sub-beams becomes wider, when the optical disk device 1 is manufactured, working efficiency can be improved.

Further, in the fourth embodiment, the center position (shown by the alternate long and short dash line “C” in FIG. 7(b)) in the depth direction of the groove part 81 is set to be the same height position but the center positions of the adjacent groove parts 81 vary in the direction perpendicular to the longitudinal direction of the groove part 81. This pattern may correspond to the astigmatism caused by other optical elements which are used in the optical disk device 1. Therefore, according to the fourth embodiment, the astigmatism caused by the optical system used in the optical disk device 1 can be absorbed by the diffraction element 8.

Alternatively, when astigmatism caused by other optical system used in the optical disk device 1 is not required to be taken into consideration, the diffraction element 8 may be structured such that the center position in the depth direction of the groove part 81 is set to be the same height position in the longitudinal direction of the groove part 81 and, in addition, the center positions of the adjacent groove parts 81 are set to be the same height position.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A diffraction element comprising:
a plurality of groove parts; and
a plurality of protruded parts which are alternately arranged with a plurality of the groove parts;
wherein a depth dimension between upper faces of the protruded parts on both sides of the groove part and a bottom part of the groove part varies according to position.

2. The diffraction element according to claim 1, wherein the depth dimension varies in a longitudinal direction of the groove part in a step manner.

3. The diffraction element according to claim 1, wherein the depth dimension continuously varies in a longitudinal direction of the groove part.

4. The diffraction element according to claim 1, wherein the depth dimensions of a plurality of the groove parts are different.

5. The diffraction element according to claim 1, wherein a center position in a depth direction of the groove part is set to be the same height position in a longitudinal direction of the groove part.

6. The diffraction element according to claim 1, wherein a center position in a depth direction of the groove part varies in a longitudinal direction of the groove part.

7. The diffraction element according to claim 1, wherein center positions in a depth direction of a plurality of the groove parts are set to be the same height position.

8. The diffraction element according to claim 1, wherein center positions in a depth direction of a plurality of the groove parts are different.

9. The diffraction element according to claim 1, wherein
the groove parts and the protruded parts which are alternately arranged each other are formed so as to comprise
a center region where a depth dimension between the bottom part of the groove part and the upper face of the protruded part is large and
both side regions where a depth dimension is smaller than the depth dimension of the center region, and
an incident area of a laser beam from a laser light source is set to extend over the center region and the both side regions.

10. The diffraction element according to claim 9, wherein a width dimension of each of a plurality of the groove parts and a width dimension each of a plurality of the protruded parts are equal to each other and a duty ratio of a grating is 50:50.

11. The diffraction element according to claim 10, wherein the bottom part of the groove part in the center region is formed deeper than the bottom part of the groove part in the both side regions, and the upper face of the protruded part in the center region is formed higher than the upper face of the protruded part in the both side regions, and
thereby the depth dimension in the center region is set to be large and the depth dimension in the both side regions is set to be small with respect to the center region.

12. The diffraction element according to claim 10, wherein the bottom part of the groove part in the center region is formed in a curved shape which is concaved at a center portion and which is continuously formed with the bottom part of the groove part in the both side regions, and
thereby the depth dimension in the center region is set to be large and the depth dimension in the both side regions is set to be small with respect to the center region.

13. The diffraction element according to claim 10, wherein the bottom part of the groove part in the center region is formed deeper than the bottom part of the groove part in the both side regions in a direction perpendicular to a longitudinal direction of the groove part, and
thereby the depth dimension in the both side regions is set to be smaller than the depth dimension in the center region.

14. An optical disk device for use with an optical disk comprising:
a diffraction element comprising:
a plurality of groove parts; and
a plurality of protruded parts which are alternately arranged with a plurality of the groove parts;
wherein a depth dimension between upper faces of the protruded parts on both sides of the groove part and a bottom part of the groove part varies according to position;
a laser light source;
a photo-detector; and
an optical system for structuring a forward path that guides a laser beam emitted from the laser light source to an optical disk and a return path that guides a return light beam reflected by the optical disk to the photo-detector;
wherein the optical system includes the diffraction element which is disposed at a middle position of the forward path as a three-beam generating element that generates a main beam comprised of a 0-order light beam and two sub-beams comprised of diffracted light beams from the laser beam emitted from the laser light source.

15. The optical disk device according to claim 14, wherein
the groove parts and the protruded parts which are alternately arranged each other are formed so as to comprise
a center region where a depth dimension between the bottom part of the groove part and the upper face of the protruded part is large and
both side regions where a depth dimension is smaller than the depth dimension of the center region, and
the laser beam emitted from the laser light source is incident on the diffraction element so as to extend over the center region and the both side regions.

16. The optical disk device according to claim 15, wherein a width dimension of each of a plurality of the groove parts and a width dimension of each of a plurality of the protruded parts are equal to each other and a duty ratio of a grating is 50:50.

17. The optical disk device according to claim 16, wherein
a far field pattern of the laser beam emitted from the laser light source is in an elliptical shape and
a major axis direction of the far field pattern corresponds to a direction perpendicular to the longitudinal direction of the groove part and
a minor axis direction of the far field pattern corresponds to the longitudinal direction of the groove part.
